(19) United States
(12) Patent Application Publication
(10) Pub. No.: US 2016/0070855 A1
(43) Pub. Date: Mar. 10, 2016

(54) Systems And Methods For Determination Of Provenance

(71) Applicants: Shahrooz Rabizadeh, Culver City, CA (US); Patrick Soon-Shiong, Culver City, CA (US); Nantomics, LLC, Culver City, CA (US)

(72) Inventors: John Zachary Sanborn, Santa Cruz, CA (US); Charles Joseph Benz, Santa Cruz, CA (US); Stephen Charles Benz, Santa Cruz, CA (US); Shahrooz Rabizadeh, Los Angeles, CA (US); Patrick Soon-Shiong, Los Angeles, CA (US)

(21) Appl. No.: 14/846,290

(22) Filed: Sep. 4, 2015

Related U.S. Application Data
(60) Provisional application No. 62/046,737, filed on Sep. 5, 2014.

(51) Int. Cl. G06F 19/22

(52) U.S. Cl. CPC G06F 19/22

(57) ABSTRACT

Systems and methods for genomic analysis are contemplated in which idiosyncratic markers or marker constellations are employed to characterize and compare genomic sequences. In especially preferred aspects, the idiosyncratic markers are predetermined SNPs and a marker profile is used in a sample record to so allow cross reference to other marker profiles of other sequences.

This application claims priority to US provisional application with the Ser. No. 62/046,737, which was filed Sep. 5, 2014.

### FIELD OF THE INVENTION

The field of the invention is computational analysis of genomic data, especially as it relates to various aspects and uses of single nucleotide polymorphism (SNP) fingerprinting.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Single nucleotide polymorphism refers to the occurrence of a variant or change at a single DNA base pair position among genomes of different individuals. Notably, SNPs are relatively common in human with a frequency of about 1:1000, and are indiscriminately located in both transcriptional and regulatory/non-coding sequences. Because of their relatively high frequency and known position, SNPs can be used in numerous fields, and have found several applications in genome-wide association studies, population genetics, and evolution studies. However, the vast amount of information has also resulted in various challenges.

For example, where SNPs are used in genome-wide association studies, an entire genome has to be sequenced for many individuals from at least two distinct groups to obtain statistically relevant association of a marker or disease with a SNP or SNP pattern. Conversely, where only a fraction of the genome or selected SNPs are analyzed, potential associations may be lost as the SNPs are widely distributed throughout an entire genome. Still further, targeted SNP analysis of patient tissue often requires dedicated equipment (high-throughput PCR) or materials (SNP arrays). In addition, once a base pair position is identified as being the locus of a SNP, such information is typically only deemed useful where a particular SNP is associated with one or more clinical features. Thus, many SNPs for which no condition or feature is known are simply deemed irrelevant and disregarded.

Consequently, even though various aspects and methods are known for SNPs, there is still a need for improved systems and methods for leveraging SNPs as an information source.

### SUMMARY OF THE INVENTION

The inventive subject matter is directed to various configurations, systems, and methods for genomic analysis in which idiosyncratic markers or marker constellations are employed to verify or rule out congruence and/or determine provenance of a biological sample relative to other genetic samples. Most preferably, the idiosyncratic markers are SNPs, and a plurality of predetermined SNPs are used to as sample-specific identifiers using their base read with complete disregard of any clinical or physiological consequence of the read in that locus.

As alternative, various other idiosyncratic markers are also deemed suitable and include length/number of various genomic repetitive sequences (e.g., SINE sequences, LINE sequences, Alu repeats), LTR sequences of viral and non-viral elements, copy number of various selected genes, and even transposon sequences. Similarly, idiosyncratic markers may also include in silico determined sets of RFLPs defined by preselected sets of nucleic acid stretches between certain recognition sites (e.g., 4-base recognition sequence, 6-base recognition sequence, 6-base recognition sequence, etc.) on preselected areas of the genome.

Therefore, in one aspect of the inventive subject matter, the inventors contemplate systems and methods of analyzing a genomic sequence of a target tissue of a mammal. In especially preferred systems and methods an analysis engine is coupled to a sequence database that stores a genomic sequence for the target tissue of the mammal. The analysis engine then characterizes a plurality of predetermined idiosyncratic markers in the genomic sequence of the target tissue, and generates an idiosyncratic marker profile using the characterized idiosyncratic markers stored as digital data. In yet another step, the analysis engine then generates or updates a first sample record for the target tissue using the idiosyncratic marker profile. The so established idiosyncratic marker profile for the first sample record is then compared by the analysis engine with a second idiosyncratic marker profile for a second sample record to thereby generate a match score, which is preferably used to annotate the first sample record.

While not limiting to the inventive subject matter, preferred predetermined idiosyncratic markers include SNPs, epigenetic modifications, numbers of repeats of repeat sequences, and/or numbers of bases between pairs of predetermined restriction endonuclease sites. Most typically, more than one predetermined idiosyncratic markers are employed, typically in a number sufficient to generate statistically meaningful results. Thus, suitable number of predetermined idiosyncratic markers will be between 100 and 10,000.

The predetermined idiosyncratic markers (e.g., SNPs) are in many instances predetermined on the basis of their known position within the genomic sequence, and/or may be randomly selected. It should be noted that the selection of the predetermined idiosyncratic markers typically is agnostic or ignorant of a disease or condition associated with the marker. Thus, and viewed from a different perspective, at least some of the predetermined idiosyncratic markers may be associated with different and unrelated diseases or conditions. Moreover, and contrary to typical use of SNPs or other idiosyncratic markers, the markers and/or profile will not include an identification of or likelihood for a disease or condition that is typically associated with the idiosyncratic markers. Depending on the nature of the idiosyncratic marker, it should be appreciated that the idiosyncratic marker profile may or may not comprise nucleotide base information for the characterized idiosyncratic markers, and may be stored, processed, and/or presented in various digital formats (e.g., idiosyncratic marker, marker profile, or sample record in VCF format).

While the sample record may also have various formats, it is typically preferred that the sample record comprises the genomic sequence, and/or that the match score comprises an identity percentage value. For example, the match score may include a matching value to a prior sample obtained from the same mammal, a matching value to an idiosyncratic marker profile that is characteristic for an ethnic group, a matching value to an idiosyncratic marker profile that is characteristic for an age group, and/or a matching value to an idiosyncratic marker profile that is characteristic for a disease.

Suitable genomic sequences for the target tissue of the mammal may cover at least one chromosome of the mammal, and more typically at least 70% of the genome or exome of the mammal. Moreover, where the target tissue of the mammal is a diseased tissue, the second sample record may be obtained from a second sample of the mammal (e.g., from a non-diseased tissue of the mammal, or previously tested same tissue).

Therefore, the inventors also contemplate a method of selecting a genomic sequence in a sequence database. Especially contemplated methods include a step of coupling an analysis engine to a sequence database that stores for an individual a first genomic sequence and an associated first idiosyncratic marker profile. Most typically, the first idiosyncratic marker profile is based on characteristics for a plurality of predetermined idiosyncratic markers in the first genomic sequence of the individual. In another step, the analysis engine then selects a second genomic sequence that has an associated second idiosyncratic marker profile (e.g., from a second individual, retrieved from the same or other sequence data base), wherein the step of selecting uses the first and second idiosyncratic marker profiles and a desired match score between the first idiosyncratic marker profile and the second idiosyncratic marker profile.

As noted earlier, while numerous alternative idiosyncratic markers are deemed suitable, preferred predetermined idiosyncratic markers include SNPs, epigenetic modifications, numbers of repeats of repeat sequences, and numbers of bases between pairs of predetermined restriction endonuclease sites, and suitable analyses use a relatively large number (e.g., between 100 and 10,000). The exact format of idiosyncratic marker profile is not limiting to the inventive subject matter, but is preferably in a format that allows rapid processing against numerous other profiles (e.g., in bit string form, and/or processing based on exclusive disjunction determination). The desired match score is preferably a user-defined cut-off score that reflects a difference between the first and second genomic sequences, but may also be predetermined based on various other factors (e.g., type of sequence analysis).

Viewed from another perspective, it should be appreciated that the inventors contemplate use of an idiosyncratic marker profile in a method of matching a first genomic sequence with a second genomic sequence. In such use, an idiosyncratic marker profile is (or has previously been) established for the first and second genomic sequences, wherein the idiosyncratic marker profile is created using a plurality of characterized idiosyncratic markers that are agnostic or ignorant of a disease or condition associated with the idiosyncratic marker. As before, suitable idiosyncratic markers typically include SNPs, epigenetic modifications, numbers of repeats of repeat sequences, and/or numbers of bases between pairs of predetermined restriction endonuclease sites in a relatively large number (e.g., between 100 and 10,000 SNPs). It should be appreciated that in such uses no information content with respect to associated conditions or diseases is required. Thus, the idiosyncratic markers may be predetermined on the basis of their known position within the genomic sequence and may or may not include nucleotide base information for the characterized idiosyncratic markers. Moreover, and similar to the teachings above, matching of the genomic sequences in contemplated uses may be based on a desired or predetermined identity percentage value between the idiosyncratic marker profiles for the first and second genomic sequences.

In a still further contemplated aspect of the inventive subject matter, the inventors contemplate a method of analyzing genomic information to determine sex of an individual. Such method will preferably include a step of coupling an analysis engine to a sequence database that stores a genomic sequence for the individual. In another step, the analysis engine determines zygosity for one or more alleles located on at least an X-chromosome to so produce a zygosity profile for the allele, and the analysis engine then derives a sex determination using the zygosity profile for the allele. Where desired, the genomic information may then be annotated with the sex determination. For example, zygosity may additionally be determined for at least one other allele on a Y-chromosome, and/or the step of determination of zygosity may include a determination of aneuploidy for sex chromosomes.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A is an exemplary graph depicting cumulative sample fraction as a function of similarity.

FIG. 1B is an exemplary graph depicting cumulative sample numbers as a function of similarity.

FIG. 2 is an exemplary illustration of a sequence analysis system according to the inventive subject matter.

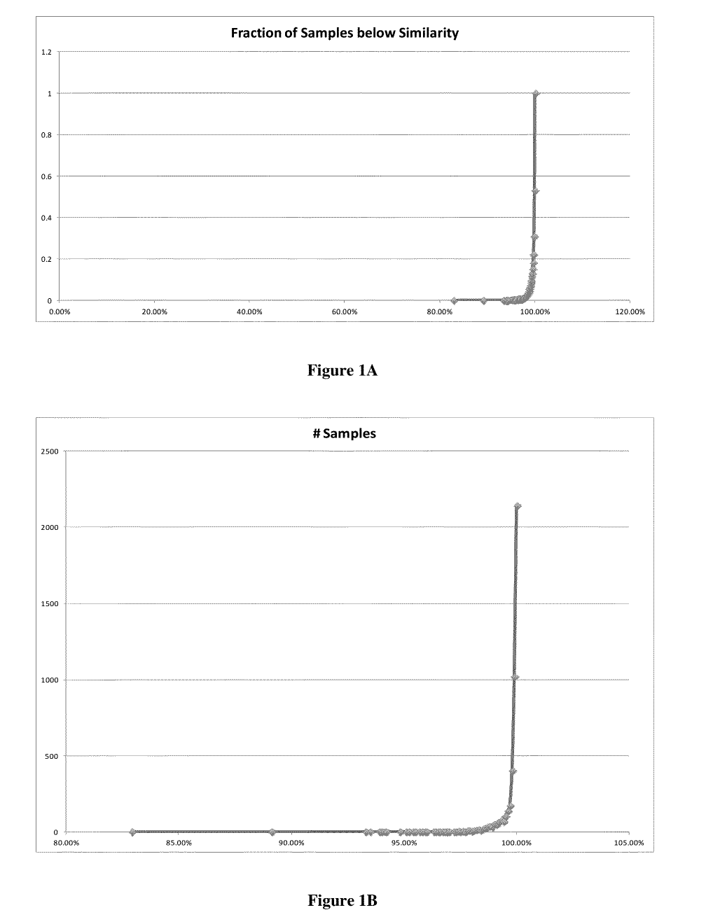

### DETAILED DESCRIPTION

The inventors have discovered that genomic sequence information can be analyzed using features in the genome without any regard to their role or function in the genome, and that these features are especially suitable due to their idiosyncratic presence in the genome. Using such idiosyncratic features will advantageously allow rapid and reliable sample matching and/or sorting, and/or determination of sample provenance or degree of relatedness.

For example, SNPs can serve as especially preferred examples of idiosyncratic features as SNPs occur at relatively high frequency in roughly statistical/random distribution throughout the genome. Thus, and viewed from a different perspective, a subset of SNPs can be selected for use as statistical beacons throughout the entire genome in a number that can be suited to a desired statistical power. Most preferably, and in the context of the inventive subject matter presented herein, the selected SNPs will be distributed throughout the entire genome but only represent a small fraction of the entire genome. For example, genome analysis may be based on a very limited subset of known SNPs, e.g., between 10% and 1%, or between 1% and 0.1%, or between 0.1% and 0.01%, of all known SNPs, or even less. Thus, number of SNPs used can be between 10-100, between 100 and 500, between 500 and 5,000, or between 5,000 and 10,000. However, it should be recognized that in other cases SNPs may be located only in one or more selected chromosomes or even loci on one or more chromosomes, and the specific analytic need and use will determine the appropriate selection of SNP number and location.

Because the SNPs are preselected and independent from any associated pathologic and/or physiologic features, constellations of SNPs can be chosen/arranged in any manner suitable for a particular purpose. Moreover, and as still further explained below, SNPs characteristics can be arranged in a marker profile, stored as a digital file for example, that can then be used to form a unified record suitable for rapid comparison against other records. In addition, contemplated marker profiles or records may be used as a search feature, parameter for data file organization, or even as a personal identifier. Thus, it should be appreciated that the analysis will typically not be performed for the purpose of diagnosis, but may instead be performed on two or more samples of the same patient (e.g., from a diseased tissue and a matched normal) to ascertain that two sequence records (e.g., from the diseased tissue and the normal) are indeed properly matched (i.e., are from the same patient). Still further, as also explained below, contemplated marker profiles or records may be associated with specific ethnicity, ancestry, etc. to so provide additional meta information to the genomic sequence information.

Of course, it should be appreciated that while SNPs are the preferred idiosyncratic markers, numerous alternative or additional idiosyncratic markers are also deemed suitable for use herein so long as such markers are representative of a unique feature of a patient's genome. For example, it is contemplated that the length and/or number of various repetitive sequences may be employed as idiosyncratic markers. Among other sequences, interspersed repeat sequences are considered appropriate as these sequences will provide both, substantially random distribution throughout the genome and high variability in length. For example, SINE sequence length and/or inter-SINE sequence distance may be used. Likewise, LINE sequence length and/or inter-LINE sequence distance may be suitable for use as idiosyncratic markers. Similarly, location and length of LTR sequences of viral and non-viral elements, copy number of various selected genes, and even transposon sequences may be employed to provide patient/sample-specific proxy measures that can be used in a manner independent from their genetic and/or physiologic function.

In still further contemplated aspects, idiosyncratic markers may also include in silico determined sets of RFLPs defined by preselected sets of nucleic acid stretches between certain recognition sites for one or more restriction endonucleases (e.g., having a 4-, 6-, or 8-base recognition sequence) on preselected areas of the genome or even the entire genome. Therefore, ‘static’ proxy measures are generally preferred. However, in further contemplated aspects of the inventive subject matter, ‘dynamic’ proxy measures are also contemplated and especially include epigenetic modifications (e.g., CpG island methylation). Moreover, while it is generally preferred that idiosyncratic markers are of the same type, it should be appreciated that various combinations of different types of idiosyncratic markers may be especially advantageous to increase statistical power while limiting the overall number of markers.

Consequently, the nature of the idiosyncratic marker will at least in part dictate the informational content of the marker. For example, where the idiosyncratic marker is a SNP, the informational content will typically include the particular position in the genome along with a base call. On the other hand, where the idiosyncratic marker is a repeat sequence, the informational content will typically include the type of sequence along with the number of repeats. Similarly, where the idiosyncratic marker is an RFLP (restriction fragment length polymorphism), the informational content will typically include the location of the sequence along with the calculated size of the fragment. Viewed from another perspective, it should thus be appreciated that the starting material for determination of the idiosyncratic marker is not a patient tissue, but an already established sequence record (e.g., SAM, BAM, FASTA, FASTQ, or VCF file) from a nucleic acid sequence determination such as whole genome sequencing, exome sequencing, RNA sequencing, etc. Thus, the starting material can be represented by a digital file storing a base-line sequence stored according to one or more digital formats. For example, a base-line sequence could include a whole genome reference sequence for a population stored in FASTA format.

For example, to validate the concept of using idiosyncratic marker profiles to ensure a patient tumor sample sequence record can be accurately matched with the corresponding sample sequence record of normal tissue of the same patient, the inventors randomly selected a priori more than 1000 SNPs and performed whole sequence genome sequencing using standard protocol on all samples. All sequence records were in BAM format and the SNP was characterized for each of the more than 1000 SNP positions. Table 1 below indicates exemplary samples and their respective origins.

TABLE 1

| | | Prepa- | |
|---|---|---|---|
| Sample | Type | ration | Source |
| HCC1954 | Tumor Cell Line | FFPE | Research Dx |
| HCC1954BL | Blood Cell Line | Fresh Frozen | Research Dx |
| HCC1143 | Tumor Cell Line | FFPE | Research Dx |
| HCC1143BL | Blood Cell Line | Fresh Frozen | Research Dx |
| NCI-H1672 | Tumor Cell Line | FFPE | Research Dx |
| NCI-BL1672 | Blood Cell Line | Fresh Frozen | Research Dx |
| NCI-H2107 | Tumor Cell Line | FFPE | Research Dx |
| NCI-BL2107 | Blood Cell Line | Fresh Frozen | Research Dx |
| WUXI-NCI- | Tumor Cell Line | FFPE | WUXI Pharmatech |
| H1672 | | | |
| WUXI-NCI- | Blood Cell Line | Fresh Frozen | WUXI Pharmatech |
| BL1672 | | | |
| WUXI-COLO829 | Tumor Cell Line | FFPE | WUXI Pharmatech |
| WUXI- | Blood Cell Line | Fresh Frozen | WUXI Pharmatech |
| COLO829BL | | | |
| WUXI-NCI- | Tumor Cell Line | FFPE | WUXI Pharmatech |
| H2107 | | | |
| WUX-NCI- | Blood Cell Line | Fresh Frozen | WUXI Pharmatech |
| BL2107 | | | |

Using the above samples and standard sequencing protocols, the following matching setup was employed as outlined in Table 2 below (BL: blood derived matched normal; LoD: Limit of detection).

TABLE 2

| | Sample 1 | Sample 2 | Expected |
|---|---|---|---|
| Contrast Name | (Tumor) | (Normal) | Result |
| HCC1954-vs-HCC1954BL | HCC1954 | HCC1954BL | Match |
| HCC1143-vs-HCC1143BL | HCC1143 | HCC1143BL | Match |
| NCI-H1672-vs-NCIBL1672 | NCI-H1672 | NCI-BL1672 | Match |
| NCI-H2107-vs-NCI- | NCI-H2107 | NCI-BL2107 | Match |
| BL2107 | | | |
| WUXI-COLO-829-vs- | WUXI- | WUXI- | Match |
| WUXI-COLO829BL | COLO829 | COLO829BL | |
| WUXI-NCI-H1672-vs- | WUXI-NCI- | WUXI-NCI- | Match |
| WUX-NCI-BL1672 | H1672 | BL1672 | |
| WUXI-NCI-H2107-vs- | WUXI-NCI- | WUXI-NCI- | Match |
| WUXI-NCI-BL2107 | H2107 | BL2107 | |
| HCC1954-LoD-25-vs- | HCC1954- | HCC1954BL | Match |
| HCC1954BL | LoD-25 | | |
| HCC1954-LoD-50-vs- | HCC1954- | HCC1954BL | Match |
| HCC1954BL | LoD-50 | | |
| HCC1143-LoD-25-vs- | HCC1143- | HCC1143BL | Match |
| HCC1143BL | LoD-25 | | |
| HCC1143-LoD-50-vs- | HCC1143- | HCC1143BL | Match |
| HCC1143BL | LoD-50 | | |
| HCC1954-vs-HCC1143BL | HCC1954 | HCC1143BL | Mismatch |
| HCC1143-vs-HCC1954BL | HCC1143 | HCC1954BL | Mismatch |
| NCI-H1672-vs-NCI- | NCI-H1672 | NCI-BL2107 | Mismatch |
| BL2107 | | | |
| WUXI-COLO-829-vs- | WUXI- | WUXI-NCI- | Mismatch |
| WUXI-NCI-BL1672 | COLO829 | BL1672 | |
| WUXI-NCI-H2107-vs- | WUXI-NCI- | WUXI- | Mismatch |
| WUXI-COLO829BL | H2107 | COLO829BL | |
| WUXI-NCI-H1672-vs- | WUXI-NCI- | WUXI-NCI- | Mismatch |
| WUXI-NCI-BL2107 | H1672 | BL2107 | |
| NCIBL1672-vs-HCC1143BL | NCI-BL1672 | HCC1143BL | Mismatch |
| NCI-H2107-vs-HCC1954 | NCI-H2107 | HCC1954 | Mismatch |
| NCI-BL2107-vs-HCC1954BL | NCI-BL2107 | HCC1954BL | Mismatch |
| WUXI-NCI-BL1672-vs- | WUXI-NCI- | WUXI- | Mismatch |
| WUXI-COLO829BL | BL1672 | COLO829BL | |
| HCC1143-vs-NCIBL1672 | HCC1143 | NCI-BL1672 | Mismatch |

In this example, the provenance similarity metric determines MATCH/MISMATCH based upon % Similarity between the two samples, where MATCH is >90% similar, and MISMATCH is <90% similar. Accuracy will be assessed by the following matrix as shown in Table 3 below (where TP is true positive, FP is false positive, TN is true negative, FN is false negative). Accuracy is then defined as (TP+TN)/(TP+TN+FP+FN).

TABLE 3

| | Match | Mismatch | |
|---|---|---|---|
| Predicted | TP | FP | Precision |
| Match | | | TP/(TP + FP) |
| Predicted | FN | TN | Negative Predictive |
| Mismatch | | | Value FN/(FN + TN) |
| | Specificity | 1-Sensitivity | |
| | TP/(TP + FN) | FP/(FP + TN) | |

Provenance was determined as noted above for similar or compatible genotypes between sample 1 and sample 2 of each contrast. The % similarity score was calculated and any pair of samples that are at least 90% similar are classified MATCH (samples belong to same person), otherwise MISMATCH (samples do not belong to same person). Tables 4-6 below feature the results of the analysis among 11 matching pairs and 11 mismatched pairs over two independently run analyses.

TABLE 4

| | | Expected | | |
|---|---|---|---|---|
| Sample 1 | Sample 2 | Result | Similarity (%) | Result |
| HCC1954 | HCC1954BL | MATCH | 100.0 | MATCH (>90%) |
| HCC1143 | HCC1143BL | MATCH | 99.9 | MATCH (>90%) |
| NCI-H1672 | NCI-BL1672 | MATCH | 99.9 | MATCH (>90%) |
| NCI-H2107 | NCI-BL2107 | MATCH | 99.2 | MATCH (>90%) |
| WUXI-NCI-H1672 | WUXI-NCI-BL1672 | MATCH | 99.9 | MATCH (>90%) |
| WUXI-NCI-H2107 | WUXI-NCI-BL2107 | MATCH | 100.0 | MATCH (>90%) |
| WUXI-COLO-829 | WUXI-COLO829BL | MATCH | 99.8 | MATCH (>90%) |
| HCC1954-LoD-25% | HCC1954BL | MATCH | 93.7 | MATCH (>90%) |
| HCC1954-LoD-50% | HCC1954BL | MATCH | 97.7 | MATCH (>90%) |
| HCC1143-LoD-25% | HCC1143BL | MATCH | 99.6 | MATCH (>90%) |
| HCC1143-LoD-50% | HCC1143BL | MATCH | 99.7 | MATCH (>90%) |
| WUXI-NCI-H2107 | WUXI-COLO829BL | MISMATCH | 51.9 | MISMATCH (<90%) |
| WUXI-NCI-BL1672 | WUXI-COLO829BL | MISMATCH | 47.0 | MISMATCH (<90%) |
| WUXI-NCI-H1672 | WUXI-NCI-BL2107 | MISMATCH | 58.2 | MISMATCH (<90%) |
| WUXI-COLO829 | WUXI-NCI-BL1672 | MISMATCH | 58.9 | MISMATCH (<90%) |
| NCI-H1672 | NCI-BL2107 | MISMATCH | 56.5 | MISMATCH (<90%) |
| NCI-H2107 | HCC1954 | MISMATCH | 48.1 | MISMATCH (<90%) |
| NCI-BL2107 | HCC1954BL | MISMATCH | 31.3 | MISMATCH (<90%) |
| NCI-BL1672 | HCC1143BL | MISMATCH | 43.8 | MISMATCH (<90%) |
| HCC1954 | HCC1143BL | MISMATCH | 47.8 | MISMATCH (<90%) |
| HCC1143 | HCC1954BL | MISMATCH | 63.9 | MISMATCH (<90%) |
| HCC1143 | NCI-BL1672 | MISMATCH | 57.8 | MISMATCH (<90%) |

TABLE 5

| | | | Simi- | |
|---|---|---|---|---|
| | | | larity | |
| Sample 1 | Sample 2 | Truth | (%) | Result |
| HCC1954 | HCC1954BL | MATCH | 100.0 | MATCH (>90%) |
| HCC1143 | HCC1143BL | MATCH | 99.9 | MATCH (>90%) |
| HCC1954 | HCC1143BL | MISMATCH | 47.8 | MISMATCH (<90%) |
| HCC1143 | HCC1954BL | MISMATCH | 63.9 | MISMATCH (<90%) |

TABLE 6

| | | | Simi- | |
|---|---|---|---|---|
| | | | larity | |
| Sample 1 | Sample 2 | Truth | (%) | Result |
| HCC1954 | HCC1954BL | MATCH | 100.0 | MATCH (>90%) |
| HCC1143 | HCC1143BL | MATCH | 99.9 | MATCH (>90%) |
| HCC1954 | HCC1143BL | MISMATCH | 47.8 | MISMATCH (<90%) |
| HCC1143 | HCC1954BL | MISMATCH | 63.9 | MISMATCH (<90%) |

With respect to suitable cut-off values for determination of a match, it should be appreciated that numerous arbitrary values or purpose-designed values can be employed. For example, arbitrary cut-off values could be 85%, 90%, 92%, 94%, 96%, or 98% minimum similarity between the sequences. On the other hand, cut-off values could also take into consideration ethnic profiles, quality or type of samples available, numbers of SNPs tested, dilution of nucleic acid in the tissue or other prep sample, etc. For example, to safeguard against diluted samples of FFPE origin, the cut-off value was selected at 90% (see Table 4, HCC1954-LoD-25% versus HCC1954BL)

In another example demonstrating the high selectivity and sensitivity of contemplated systems and methods, the inventors compared previously sequenced pairs of tumors and normal exome sequences obtained from the database of The Cancer Genome Atlas belonging to unique patients using a system as described above. As can be seen from Table 7 below, for a total of 4,756 matched tumor-normal sequences (9,512 sequences as BAM files), the fraction of similarity is relatively low even for fairly high similarity scores (e.g., 98% similarity), and only above very high similarity scores (e.g., 99.5% similarity) begins to exponentially rise.

TABLE 7

| | # | # Sample below | Fraction of Samples below |
|---|---|---|---|
| Similarity | Samples | Similarity (cumulative) | Similarity (cumulative) |
| 82.90% | 1 | 1 | 0.00021853 |
| 89.10% | 1 | 2 | 0.00043706 |
| 93.30% | 2 | 4 | 0.00087413 |
| 93.50% | 1 | 5 | 0.00109266 |
| 93.90% | 1 | 6 | 0.00131119 |
| 94.00% | 2 | 8 | 0.00174825 |
| 94.10% | 1 | 9 | 0.00196678 |
| 94.20% | 1 | 10 | 0.00218531 |
| 94.80% | 2 | 12 | 0.00262238 |
| 95.10% | 1 | 13 | 0.00284091 |
| 95.20% | 1 | 14 | 0.00305944 |
| 95.40% | 1 | 15 | 0.00327797 |
| 95.50% | 2 | 17 | 0.00371503 |
| 95.70% | 1 | 18 | 0.00393357 |
| 95.80% | 1 | 19 | 0.0041521 |
| 95.90% | 1 | 20 | 0.00437063 |
| 96.00% | 2 | 22 | 0.00480769 |
| 96.30% | 2 | 24 | 0.00524476 |
| 96.40% | 2 | 26 | 0.00568182 |
| 96.50% | 1 | 27 | 0.00590035 |
| 96.60% | 1 | 28 | 0.00611888 |
| 96.70% | 3 | 31 | 0.00677448 |
| 96.80% | 2 | 33 | 0.00721154 |
| 96.90% | 1 | 34 | 0.00743007 |
| 97.00% | 3 | 37 | 0.00808566 |
| 97.20% | 1 | 38 | 0.0083042 |
| 97.30% | 2 | 40 | 0.00874126 |
| 97.40% | 5 | 45 | 0.00983392 |
| 97.50% | 2 | 47 | 0.01027098 |
| 97.60% | 6 | 53 | 0.01158217 |
| 97.70% | 2 | 55 | 0.01201923 |
| 97.80% | 10 | 65 | 0.01420455 |
| 97.90% | 11 | 76 | 0.01660839 |
| 98.00% | 7 | 83 | 0.01813811 |
| 98.10% | 10 | 93 | 0.02032343 |
| 98.20% | 13 | 106 | 0.02316434 |
| 98.30% | 19 | 125 | 0.02731643 |
| 98.40% | 12 | 137 | 0.02993881 |
| 98.50% | 21 | 158 | 0.03452797 |
| 98.60% | 25 | 183 | 0.03999126 |
| 98.70% | 35 | 218 | 0.04763986 |
| 98.80% | 38 | 256 | 0.05594406 |
| 98.90% | 33 | 289 | 0.06315559 |
| 99.00% | 54 | 343 | 0.07495629 |
| 99.10% | 48 | 391 | 0.0854458 |
| 99.20% | 63 | 454 | 0.09921329 |
| 99.30% | 76 | 530 | 0.11582168 |
| 99.40% | 68 | 598 | 0.13068182 |
| 99.50% | 103 | 701 | 0.15319056 |
| 99.60% | 137 | 838 | 0.18312937 |
| 99.70% | 173 | 1011 | 0.22093531 |
| 99.80% | 403 | 1414 | 0.3090035 |
| 99.90% | 1019 | 2433 | 0.53168706 |
| 100.00% | 2143 | 4576 | 1 |

Consequently, in one exemplary aspect of the inventive subject matter, the inventors contemplate various methods of analyzing a genomic sequence of a target tissue of a mammal using one or more idiosyncratic markers. Most typically, contemplated methods will make use of an analysis engine that is informationally coupled to a sequence database that stores genomic sequences for respective target tissue of a plurality of mammals. Of course, it should be appreciated that the genomic sequences may be in a variety of formats, and that the particular nature of the format is not limiting to the inventive subject matter presented herein. However, especially preferred formats will be formatted to at least some degree and especially preferred formats include SAM, BAM, or VCF formats.

The analysis engine will then characterize a plurality of predetermined idiosyncratic markers in the genomic sequence of the target tissue. Of course, it should be appreciated that the characterization will vary depending on the type of idiosyncratic marker that is being used. For example, where the marker is a SNP, the characterization will include a particular base at a particular location (e.g., expressed as chr:bp, base number in specific allele, or specific SNP designation). On the other hand, where the marker is a repeat sequence, the characterization will include a particular identifier for the sequence and the number of repeats, preferably with location information. Of course, it should be recognized that the analysis/characterization will be performed for a plurality of idiosyncratic markers (e.g., a group of between 100 and 10,000 markers).

Once all markers are characterized, it is contemplated that the analysis engine will then generate an idiosyncratic marker profile using the previously characterized markers. Such profile may be in a raw data format, or processed by a specific rule. Regardless of the format, it is generally preferred that a sample record is then generated or updated by the analysis engine, wherein the sample record is specific for the target tissue and includes the idiosyncratic marker profile in raw or processed form. While not limiting to the inventive subject matter, it is contemplated that the idiosyncratic marker profile may be attached to (or otherwise integrated with) genomic sequence information. Such is particularly useful where the analysis engine further compares the idiosyncratic marker profile in the sample record with another idiosyncratic marker profile of another sample record to so generate a match score. The match score may then be used in various manners (e.g., for annotation of the sample record). Moreover, using idiosyncratic marker profiles in a manner that is agnostic (information not available) or ignorant (available information not used) with respect to a condition or disease otherwise associated with a idiosyncratic marker, and especially SNP, highly variable but positionally invariable information can be used as a beacon to ascertain that two particular sequences are in fact from the same patient. Such control is especially advantageous for electronic records of genomic sequences where misidentification of a sample in a clinical laboratory may lead to a perfectly valid and high quality, but improperly assigned sequence record. Viewed from another perspective, it should be appreciated that contemplated systems and methods allow for confirmation of pairings of two sequences from the same patient, or for finding a matching sequence in a collection of sequences that may originate from the same patient (or a directly related relative or same ethnic group).

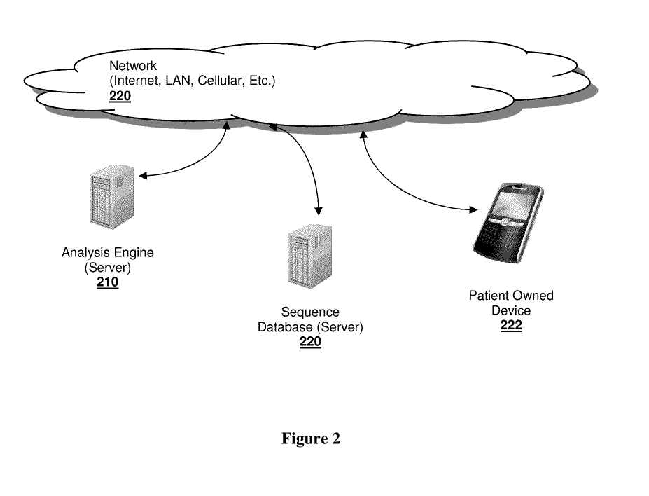

Once exemplary system for system for analysis of a genomic sequence of a target tissue of a mammal is schematically depicted in FIG. 2 where system 200 comprises an analysis engine 210 that is coupled via a network 215 to a sequence database 220 that stores genomic sequences for target tissues of multiple patients. Of course, it should be appreciated that there are numerous additional sources of genomic sequences (e.g., sequencing service laboratory, reference database, memory of a patient-owned device 222, etc.), and all of them are deemed suitable for use herein. In a typical system, the analysis engine is configured to characterize a plurality of predetermined idiosyncratic markers in the genomic sequence of the target tissue, and to generate an idiosyncratic marker profile using the characterized idiosyncratic markers, to generate or update a first sample record for the target tissue using the idiosyncratic marker profile, to compare the idiosyncratic marker profile in the first sample record with a second idiosyncratic marker profile in a second sample record to thereby generate a match score; and to annotate the first sample record using the match score.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. With respect to the idiosyncratic markers it is generally preferred that the markers are a set of user selected or predetermined idiosyncratic markers that are less than the totality of all markers available in the genome. For example, idiosyncratic markers may include SNPs, a quantitative measure of repeat sequences, short tandem repeat (STR), a numbers of bases between predetermined restriction endonuclease sites, and/or epigenetic modifications. User selection or predetermination is in most cases such that the markers are randomly distributed throughout the genome of the mammal, or that the markers are statistically evenly distributed throughout a genome of the mammal. While markers are preferably representative of the entire genome, it is also contemplated that the genomic sequence for the target tissue of the mammal covers at least one chromosome of the mammal, or at least 70% of the genome of the mammal.

As will be readily appreciated, the analysis contemplated herein will be suitable for many uses, however, is particularly contemplated for analyses where the target tissue of the mammal is a diseased tissue and where the second sample record is obtained from a second non-diseased sample of the same (or related or unrelated) mammal. Therefore, where the second sample is a reference tissue of the same mammal, contemplated analysis will be particularly suitable in the validation that the diseased sample and the non-diseased sample are properly matched samples from the same mammal/patient, or properly matched with respect to another parameter (e.g., ethnicity, familial origin, etc.). Such profiling may be especially advantageous where the sample is from a patient having a disease that is differently treated among different ethnic populations. Using sets of SNPs the inventors contemplate that ethnicity or population ancestry of individuals can be established that can be a determinate in the types of somatic alterations. For example, EGFR mutations in lung cancer are a relatively rare event in North American Caucasians but reasonably prevalent in Asian lung cancer populations. These may be more or less responsive to particular EGFR therapies and stratification by ethnicity may thus be advisable. To that end, a match score may be implemented that comprises a matching value to another sample, for example, a prior sample obtained from the same mammal, a matching value to an idiosyncratic marker profile that is characteristic for an ethnic group, a matching value to an idiosyncratic marker profile that is characteristic for an age group, and a matching value to an idiosyncratic marker profile that is characteristic for a disease.

In yet another contemplated aspect of the inventive subject matter, the inventors also contemplate various other uses of idiosyncratic markers and idiosyncratic marker profiles for matching or selecting corresponding, related, or similar other genomic sequences. For example, the inventors contemplate a method of selecting a genomic sequence in a sequence database using analytics engine that is coupled to a sequence database that stores a genomic sequence and an associated idiosyncratic marker profile for an individual. As discussed before, it is generally preferred that the idiosyncratic marker profile is based on one or more characteristics for a number of predetermined idiosyncratic markers in the genomic sequence of the individual, and it is still further preferred that the idiosyncratic marker profile is in a processed form to facilitate comparison. For example, the processed form may be a bit string form. In such systems, the analytics engine can then select a second genomic sequence having an associated second idiosyncratic marker profile. Most typically, the selection will use the idiosyncratic marker profile and a desired match score between the idiosyncratic marker profile and the second idiosyncratic marker profile (e.g., must have at least 90% identity between profiles).

As already noted before, it is generally preferred that the predetermined idiosyncratic markers are SNPs, numbers/locations of repeat sequences, numbers of bases between predetermined restriction endonuclease sites, and/or epigenetic modifications, and that the number of predetermined idiosyncratic markers is between 100 and 10,000 markers to facilitate computational analysis. With respect to the desired match score it is generally preferred that the match score is based on exclusive disjunction determination and/or that the desired match score is a user-defined cut-off score for a “distance” between the first and second genomic sequences.

In yet another contemplated aspect of the inventive subject matter, the inventors further contemplate a method of analyzing genomic information to determine sex of an individual. In such methods, it should be appreciated that an analytics engine can be used in conjunction with a sequence database that stores a genomic sequence for the individual, where the analytics engine determines the zygosity for at least one allele located on at least the X-chromosome (and more typically the X- and Y-chromosomes) to so produce a zygosity profile for the allele(s). Once determined, the analytics engine can then make a sex determination using the zygosity profile for the allele. Where desired, the genomic information is then annotated with the sex determination. Most notably, such sex determination is simple and can also take into account aneuploidy for sex chromosomes to so readily evaluate a genomic sequence as belonging to a patient with Klinefelter syndrome, Turner syndrome, XXY syndrome, or Xp22 deletion, etc.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of analyzing a genomic sequence of a target tissue of a mammal, comprising:
coupling an analysis engine to a sequence database that stores a genomic sequence for the target tissue of the mammal;
characterizing, by the analysis engine, a plurality of predetermined idiosyncratic markers in the genomic sequence of the target tissue, and generating an idiosyncratic marker profile using the characterized idiosyncratic markers;
generating or updating, by the analysis engine, a first sample record for the target tissue using the idiosyncratic marker profile;
comparing, by the analysis engine, the idiosyncratic marker profile in the first sample record with a second idiosyncratic marker profile in a second sample record to thereby generate a match score; and
annotating the first sample record using the match score.

2. The method of claim 1 wherein the predetermined idiosyncratic markers are selected from the group consisting of SNPs, epigenetic modifications, numbers of repeats of repeat sequences, and numbers of bases between pairs of predetermined restriction endonuclease sites.

3. The method of claim 1 wherein the plurality of predetermined idiosyncratic markers includes between 100 and 10,000 predetermined idiosyncratic markers.

4. The method of claim 1 wherein the predetermined idiosyncratic markers are SNPs.

5. The method of claim 1 wherein the predetermined idiosyncratic markers are predetermined on the basis of their known position within the genomic sequence.

6. The method of claim 1 wherein the predetermined idiosyncratic markers are predetermined on the basis of random selection and wherein the random selection is agnostic or ignorant of a disease or condition associated with the marker.

7. The method of claim 1 wherein at least some of the predetermined idiosyncratic markers are associated with respective diseases or conditions, and wherein the diseases or conditions are unrelated diseases or conditions.

8. The method of claim 1 wherein the idiosyncratic marker profile does not include identification of a disease or condition associated with at least some of the characterized idiosyncratic markers.

9. The method of claim 1 wherein the idiosyncratic marker profile comprises nucleotide base information for the characterized idiosyncratic markers.

10. The method of claim 1 wherein the sample record has a VCF format.

11. The method of claim 1 wherein the sample record comprises the genomic sequence.

12. The method of claim 1 wherein the match score comprises an identity percentage value.

13. The method of claim 1 wherein the match score comprises a matching value to at least one of a prior sample obtained from the same mammal, a matching value to an idiosyncratic marker profile that is characteristic for an ethnic group, a matching value to an idiosyncratic marker profile that is characteristic for an age group, and a matching value to an idiosyncratic marker profile that is characteristic for a disease.

14. The method of claim 1 wherein the genomic sequence for the target tissue of the mammal covers at least one chromosome of the mammal.

15. The method of claim 1 wherein the genomic sequence for the target tissue of the mammal covers at least 70% of the genome of the mammal.

16. The method of claim 1 wherein the target tissue of the mammal is a diseased tissue, and wherein the second sample record is obtained from a second sample of the mammal.

17. The method of claim 16 wherein the second sample of the mammal is from a non-diseased tissue of the mammal.

18. A method of selecting a genomic sequence in a sequence database, comprising:
coupling an analysis engine to a sequence database that stores for an individual a first genomic sequence and an associated first idiosyncratic marker profile;
wherein the first idiosyncratic marker profile is based on characteristics for a plurality of predetermined idiosyncratic markers in the first genomic sequence of the individual;
selecting, by the analysis engine, a second genomic sequence having an associated second idiosyncratic marker profile; and
wherein the step of selecting uses the first and second idiosyncratic marker profiles and a desired match score between the first idiosyncratic marker profile and the second idiosyncratic marker profile.

19. The method of claim 18 wherein the predetermined idiosyncratic markers are selected from the group consisting of SNPs, epigenetic modifications, numbers of repeats of repeat sequences, and numbers of bases between pairs of predetermined restriction endonuclease sites.

20. The method of claim 18 wherein the plurality of predetermined idiosyncratic markers includes between 100 and 10,000 predetermined idiosyncratic markers.

21. The method of claim 18 wherein the idiosyncratic marker profile is in a bit string form.

22. The method of claim 18 wherein the desired match score is based on exclusive disjunction determination.

23. The method of claim 18 wherein the desired match score is a user-defined cut-off score for difference between the first and second genomic sequences.

24. The method of claim 18 wherein the second genomic sequence having the associated second idiosyncratic marker profile is derived from a second individual.

25. The method of claim 18 wherein the second genomic sequence having an associated second idiosyncratic marker profile is retrieved from the sequence data base.

26. A system for analysis of a genomic sequence of a target tissue of a mammal, comprising:
an analysis engine coupled to a sequence database that stores a genomic sequence for the target tissue of the mammal;
wherein the analysis engine is configured to
characterize a plurality of predetermined idiosyncratic markers in the genomic sequence of the target tissue, and to generate an idiosyncratic marker profile using the characterized idiosyncratic markers;
generate or update a first sample record for the target tissue using the idiosyncratic marker profile;
compare the idiosyncratic marker profile in the first sample record with a second idiosyncratic marker profile in a second sample record to thereby generate a match score; and
annotate the first sample record using the match score.

27. The system of claim 26 wherein the predetermined idiosyncratic markers are selected from the group consisting of SNPs, epigenetic modifications, numbers of repeats of repeat sequences, and numbers of bases between pairs of predetermined restriction endonuclease sites.

28. The system of claim 26 wherein the plurality of predetermined idiosyncratic markers includes between 100 and 10,000 predetermined idiosyncratic markers.

29. The system of claim 26 wherein the predetermined idiosyncratic markers are SNPs.

30. The system of claim 26 wherein the predetermined idiosyncratic markers are predetermined on the basis of their known position within the genomic sequence.

31. The system of claim 26 wherein the predetermined idiosyncratic markers are predetermined on the basis of random selection and wherein the random selection is agnostic or ignorant of a disease or condition associated with the marker.

32. The system of claim 26 wherein at least some of the predetermined idiosyncratic markers are associated with respective diseases or conditions, and wherein the diseases or conditions are unrelated diseases or conditions.

33. The system of claim 26 wherein the idiosyncratic marker profile comprises nucleotide base information for the characterized idiosyncratic markers.

34. The system of claim 26 wherein the sample record has a VCF format.

35. The system of claim 26 wherein the sample record comprises the genomic sequence.

36. The system of claim 26 wherein the match score comprises an identity percentage value.

37. The system of claim 26 wherein the match score comprises a matching value to at least one of a prior sample obtained from the same mammal, a matching value to an idiosyncratic marker profile that is characteristic for an ethnic group, a matching value to an idiosyncratic marker profile that is characteristic for an age group, and a matching value to an idiosyncratic marker profile that is characteristic for a disease.

38. The system of claim 26 wherein the genomic sequence for the target tissue of the mammal covers at least one chromosome of the mammal.

39. A method of analyzing genomic information to determine sex of a individual, comprising:
coupling an analysis engine to a sequence database that stores a genomic sequence for the individual;
determining, by the analysis engine, zygosity for at least one allele located on at least an X-chromosome to thereby produce a zygosity profile for the allele;
deriving, by the analysis engine, a sex determination using the zygosity profile for the allele; and
annotating the genomic information with the sex determination.

40. The method of claim 39 wherein the zygosity is additionally determined for at least one other allele on an Y-chromosome.

41. The method of claim 39 wherein the determination includes determination of aneuploidy for sex chromosomes.
